(19) United States
(12) Patent Application Publication
(10) Pub. No.: US 2020/0281349 A1
(43) Pub. Date: Sep. 10, 2020

(54) Height Adjustable Work Surface

(71) Applicants: Daniel Grabowski, East Grand Rapids, MI (US); Michael Johnson, West Olive, MI (US); David Melvin Gresham, East Hampton, NY (US)

(72) Inventors: Daniel Grabowski, East Grand Rapids, MI (US); Michael Johnson, West Olive, MI (US); David Melvin Gresham, East Hampton, NY (US)

(73) Assignee: DSA International, LLC, Zeeland, MI (US)

(21) Appl. No.: 16/058,975

(22) Filed: Aug. 8, 2018

(51) Int. Cl. A47B 13/08; A47B 9/00; F16D 63/00; A47B 13/06; A47B 17/02; A47B 21/02

(52) U.S. Cl. CPC A47B 13/081; A47B 9/00; F16D 63/008; F16D 2121/14; A47B 13/088; A47B 17/02; A47B 21/02; A47B 13/06

(57) ABSTRACT

A height adjustable work surface is described that may be utilized as a standalone desk or table, or integrated with a larger work surface to provide selective height adjustability to only a portion of a work surface. The height adjustable work surface preferably utilizes a modular trapezoidal frame structure, including trapezoid tube weldments, corner castings and machined hardened connector pins. The lift mechanism preferably includes parallelogram linkages, pneumatic gas cylinders, sliding brake bar mechanism and brake release handles to provide height adjustment functionality.

### TECHNICAL FIELD

The present invention is directed to height adjustable work surfaces, a modular, trapezoidal table/desk frame structure and mechanisms for providing height adjustability to a work surface.

### BACKGROUND OF INVENTION

The present invention relates to a new and useful height adjustable work surface. The novel work surface includes a portion that may raise from a start position substantially planar with the rest of the work surface so that a user may utilize the raised portion while standing, or at any height that is more comfortable for the individual user. The height adjustable work surface portion may be utilized in a standalone desk or table, as part of modular and reconfigurable workstations or as components of a conference table, allowing each person at the table to stand and raise their individual work surface if desired. The novel work surface of the present invention may also be utilized in unconventional and heretofore unknown applications, such as, for example, a coffee table with a portion that raises to a height allowing that portion to be used as a desk and workspace.

The invention preferably utilizes a novel modular trapezoidal frame structure that includes trapezoid tube weldments, corner castings and machined hardened connector pins that provide a sturdy, customizable, and aesthetically pleasing frame for nearly any table, desk or workstation application that is easily assembled, disassembled and modified. A unique center weldment is utilized with the modular trapezoidal frame structure to provide a support for the lift mechanism of the height adjustable work surface portion.

The lift mechanism preferably utilizes parallelogram linkages, pneumatic gas cylinders, sliding brake bar mechanisms and brake release handles to provide the height adjustment functionality of the present invention. This combination of elements allows the work surface portion to be easily and safely lifted or lowered by any person and set at the exact position that is most comfortable and desired by that individual.

### SUMMARY OF INVENTION

The inventors have identified, among other things, that a problem to be solved can include providing an efficient work surface that has a conventional table portion that is static and an adjustable table portion that can be raised or lowered. The inventors have recognized that a relatable problem can include a person only needing to raise or lower specific items on their work surface, for example, keyboard, monitor, and writing pad. Another recognizable problem is having to raise and lower an entire work surface, when only certain items need to be raised and others kept lowered.

The present invention can provide a solution to this problem by providing a height adjustable work surface that contains a conventional table portion and a height adjustable portion. The combined work surface, with a static portion and a height adjustable portion, can have a modular trapezoidal frame structure that provides a sturdy and aesthetically pleasing frame and a lift mechanism that allows the work surface portion to be easily and safely lifted or lowered by any person.

The height adjustable work surface can be utilized in reconfigurable, multi-person workstations for multiple workers and can be incorporated in a conference table allowing individuals to stand as needed.

In another example, the height adjustable work surface functionality can be incorporated on a mobile table with casters or can be wall mounted of mounted between storage units.

The height adjustable work surface can include a modular trapezoidal frame structure. The trapezoidal frame structure can include trapezoid tube weldments, corner castings and machined hardened connector pins that provide a heavy, customizable, and aesthetically pleasing frame that is easily assembled, dissembled and modified.

The corner castings connect to two trapezoidal tube weldments and a leg weldment. The corner castings provide modular functionality, allowing different legs to be used with the casting, and different lengths of trapezoid tube weldments to be used, so that table tops of different sizes may be used in conjunction with the trapezoid tube weldments and corner castings.

The height adjustable work surface may be integrated with the trapezoidal frame with a center weldment structure. The center weldment is constructed of welded components with the rear and front weldments being trapezoidal tubes and the connecting center tubes being rectangular. In at least one example, the center weldment can be used with a single table frame or used in multiple and multi-person table frames.

The lift mechanism utilizes parallelogram linkages, pneumatic gas cylinders, sliding brake bar mechanisms and brake release handles. The brake bar and locking mechanism can include two brake castings that slide along a hardened brake held as the lift mechanism is raised and lowered.

### BRIEF DESCRIPTION OF DRAWINGS

In the drawings, which are not necessarily drawn to scale, the numerals may describe components in different views. The drawings illustrate, generally, by way of example, but not by way of limitation, various examples and embodiments discussed in the present document.

FIG. 1 is a perspective view of a height adjustable work surface according to an example of the present invention.

FIG. 2 is a partial perspective view of FIG. 1 having the height adjustable portion in a raised position according to an example of the present invention.

FIG. 3 is a partial perspective view of a height adjustable work surface depicted in FIG. 1 utilized in reconfigurable, multi-person workstations for multiple users and workers according to an example of the present invention.

FIG. 4 is a partial perspective view of a height adjustable work surface depicted FIG. 1 incorporated on a mobile table with casters according to an example of the present invention.

FIG. 5 is a schematic side view of a trapezoid tube weldment according to an example of the present invention.

FIG. 6 is a perspective view of a modular trapezoid frame table according to an example of the present invention.

FIG. 7 is a perspective view of a fixed and assembled modular trapezoid frame structure depicted in FIG. 6 with support beams, according to an example of the present invention.

FIG. 8 is a perspective view of a corner casting assembly according to an example of the present invention.

FIG. 9 is a perspective view of the configuration of a corner casting depicted FIG. 8 according to an example of the present invention.

FIG. 10 is a perspective view of the configuration of a trapezoid frame table depicted in FIG. 5 according to an example of the present invention.

FIG. 11 is a schematic side view of an integrated machine hardened pin according to an example of the present invention.

FIG. 12 is a perspective view of the configuration of a corner casting assembly according to an example of the present invention.

FIG. 13 is a perspective view of a height adjustable work surface as depicted in FIG. 1 integrated with a novel trapezoidal frame structure with a center weldment structure according to an example of the present invention.

FIG. 14 is an aerial view of a height adjustable work surface as depicted in FIG. 1 integrated with a novel trapezoidal frame structure with a center weldment structure according to an example of the present invention.

FIG. 15 is a perspective view of a height adjustable work surface as depicted in FIG. 1 used in alternative corner casting and connectivity configurations of multiple table frames according to an example of the present invention.

FIG. 16 is a perspective view of a height adjustable work surface as depicted in FIG. 1 used in alternative corner casting and connectivity configurations of multiple table frames according to an example of the present invention.

FIG. 17 is a perspective view of a height adjustable work surface as depicted in FIG. 1 used in alternative corner casting and connectivity configurations of multiple table frames according to an example of the present invention.

FIG. 18 is a perspective view of the height adjustable work surface as depicted in FIG. 1 with the lift mechanism according to an example of the present invention.

FIG. 19 is an exploded perspective view of the lift mechanism depicted in FIG. 18 according to an example of the present invention.

FIG. 20 is a perspective view of a brake assembly as depicted in the lift mechanism which includes a brake housing, brake plates, and a spring according to an example of the present invention.

FIG. 21 is a perspective view of a brake assembly as depicted in the lift mechanism which includes a brake housing, brake plates, and a spring according to an example of the present invention.

FIG. 22 is a perspective view of the locked position of the lift mechanism including the brake housing and brake bar according to an example of the present invention.

### DESCRIPTION OF PREFERRED EMBODIMENTS

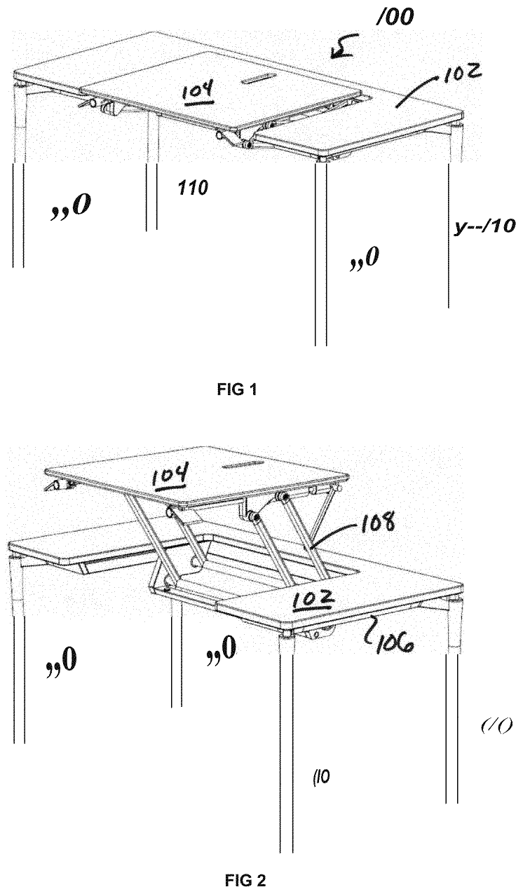

As depicted in FIGS. 1 and 2, a desk 100 can include a static conventional table portion 102, a height adjustable portion 104, a trapezoidal frame structure 106, a lift mechanism 108 and legs 110. In the lowered position, as shown in FIG. 1, the conventional table portion 102 is substantially planar with the height adjustable portion 104.

As depicted in FIG. 2, the height adjustable portion 104 may be raised by operation of the lift mechanism 108. In this position, the work surface may be utilized by a person in a standing position.

The dual nature of the desk, with a static portion and a height adjustable portion, provides many advantages. First, the desk 100 may be utilized as a conventional work surface by a person in a sitting position with the height adjustable portion in the lowered position. Further, the conventional table portion 102 provides a static surface for items such as a telephone, lights, pictures, resource materials, office supplies, speakers, etc. that do not need to be raised when a person elects to work in a standing position. The height adjustable portion, 104, is configured to rise straight up and raise or lower items that a person is actually using to work. These items can include a keyboard, monitor, writing pad, computer mouse, etc. This is advantageous to a user where they do not need to move all items on a work surface in order to achieve a desired comfortable height.

A table with only a portion that is height adjustable offers many advantages. First, significantly less weight must be raised and lowered if only a portion of the table top is height adjustable, most significantly, the weight of the table top itself. Also, only the items that a person is actually using to work are raised and lowered, while other items typically found on a desk may remain static. In addition to reducing the weight that must be raised and lowered, an office can maintain a less cluttered appearance if most items on a desk remain at the lower, static position.

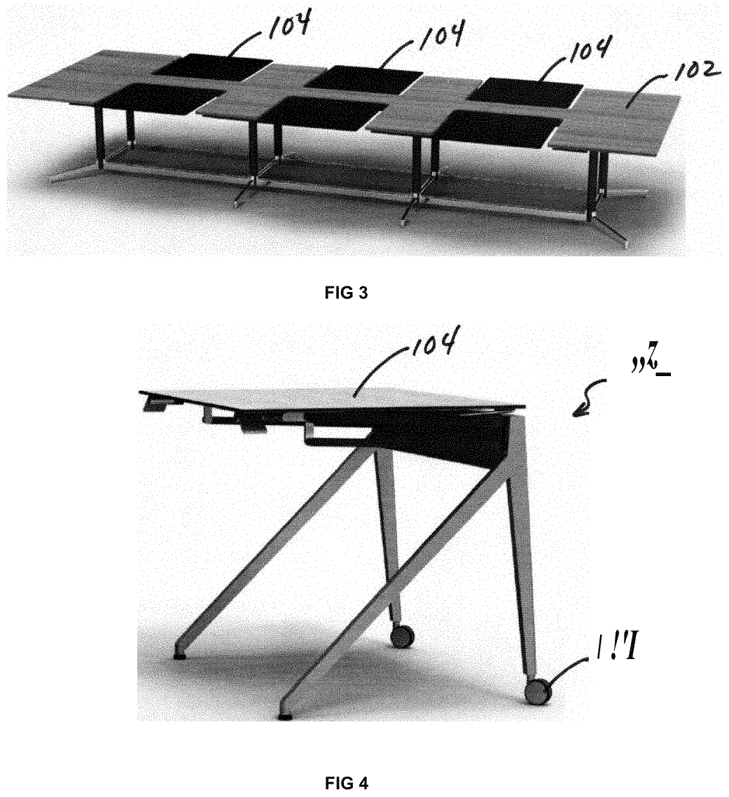

As illustrated in FIG. 3, multiple height adjustable work surfaces can be utilized in multi-person workstations and/or conference tables for multiple workers and users. For example, the conference table of FIG. 3 include a static conventional table portion 102 and multiple height adjustable portions 104. Individuals at conference meetings or during presentations, can raise the height adjustable work surfaces 104 in front of them to assist with presentations. This provides a more efficient and comfortable method of conducting meetings and presentations.

As illustrated in FIG. 4, the height adjustable work surface 104 can be utilized in a mobile table 112 with casters 114. In this configuration, users can easily relocate the height adjustable work surface 104, which provides many advantages. For example, the mobile table 112 can be used for displays or monitors, which can easily be raised for presentations or exhibitions.

The height adjustable work surface of the present invention can also be used in many other configurations. For example, two height adjustable work portions may be provided as a portion of a single table, creating a dual desking configuration. The height adjustable portions may be configured face to face on a substantially square table configuration, or side by side in a rectangular table configuration.

Applicants contemplate many other applications for their novel invention. For example, a standard coffee table could include a height adjustable portion that could be raised to create a desk, allowing a single piece of furniture to serve two functions. A standard dining table could include a height adjustable portion to accommodate a person in a wheelchair, or a child in a high chair, and then returned to its former standard position substantially planar with the rest of the table. The height adjustable table may also be wall mounted, allowing for a standalone height adjustable work surface, or mounted between storage units that are mounted to a wall or sitting on the floor. These and other examples of uses fall within the scope of the present invention, as described herein.

Although nearly any structural table frame may be utilized with Applicants' novel height adjustable table, Applicants have also developed, and herein disclose, a novel modular trapezoidal frame structure. Applicants novel frame, which may be used in applications other than with a height adjustable table portion, includes trapezoid tube weldments, corner castings and machined hardened connector pins that provide a heavy, customizable, and aesthetically pleasing frame that is easily assembled, dissembled and modified.

Applicants' novel modular trapezoidal frame structure is first described in use with a conventional table, and then in connection with Applicants' height adjustable table.

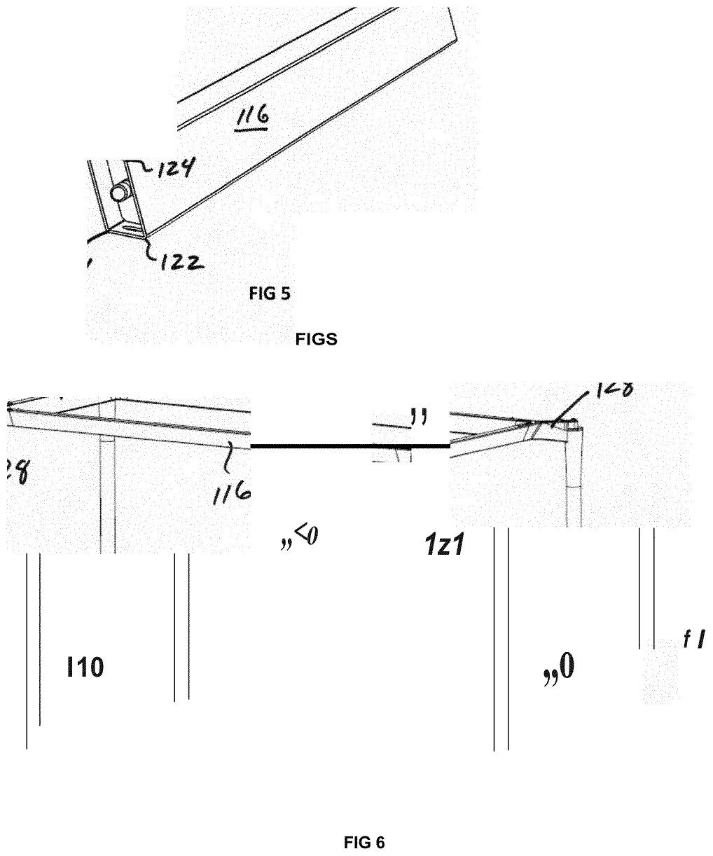

Applicants utilize a trapezoid tube weldment 116, as shown in FIG. 5, to construct the frame for a trapezoid frame table, shown in FIG. 6. The trapezoid tube weldments 116 are connected by corner castings 128 which are connected to legs 110 to create the table frame.

The angle of the trapezoid of each trapezoid tube weldment 116 is preferably 25-155-25-155, with the acute angles 122 of the trapezoid being 25 degrees and the obtuse angles 124 of the trapezoid being 155 degrees. Those of skill in the art will recognize that other angles for the trapezoid may be used to achieve the same functionality.

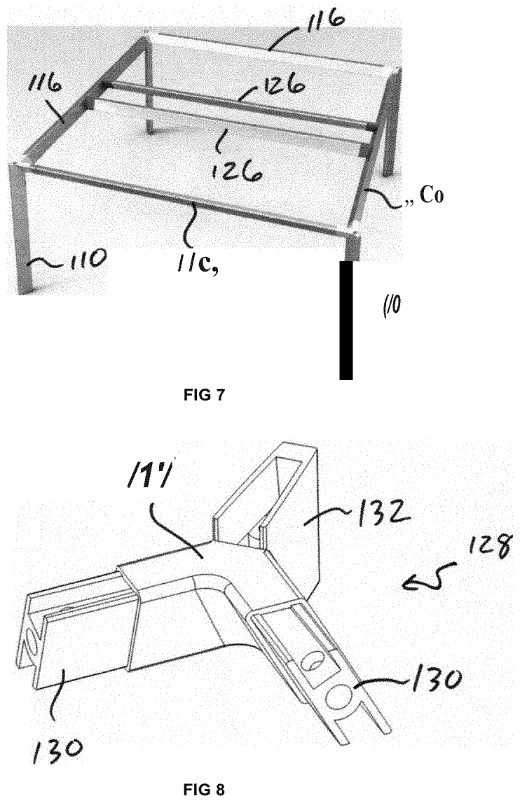

The trapezoidal table tube weldments provide many advantages over conventional rectangular tube weldments. In addition to a pleasing aesthetic, trapezoidal beams provide the same structural stability with a lower profile, providing more leg clearance beneath the table. Also, accessories or support beams 126, as shown in FIG. 7, can be dropped down into the “cone” formed by opposing trapezoids, allowing for easier securement methods compared to rectangular frame elements.

The trapezoidal frame may have alternative supports. For example, one end could have legs with the other end supported by a wall, panel system or a furniture component.

The trapezoid tube weldments 116 of the present invention are preferably used in conjunction with a corner casting 128, an example of which if shown in FIG. 8. The corner casting 128 includes two insertion portions 130 and a leg connection portion 132, with the two insertion portions 130 and leg connection portion 132 connected to a center portion 134, and oriented around the center portion at 120 degrees from each other. As will be described further, the insertion portions 130 of the corner casting 128 connect to one end of a trapezoid tube weldment 116 and the leg connection portion 132 of the corner casting 128 connects to a leg 110.

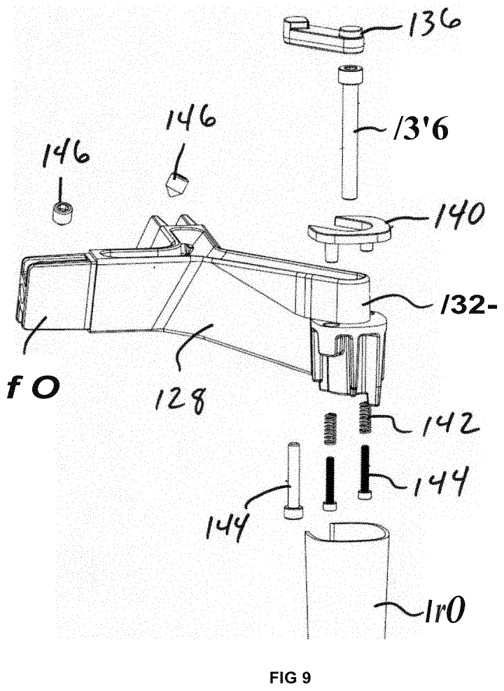

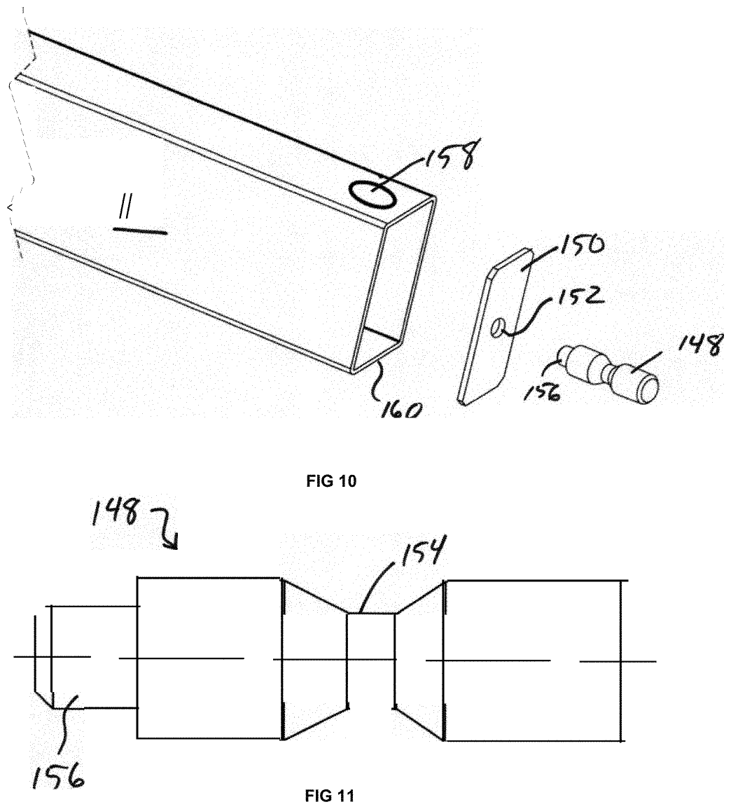

The inventor's preferred configuration of the corner casting 128 is shown in FIG. 9, along with examples of hardware that may be used to connect the corner casting 128 to legs 110 and trapezoid tube weldments 116. The hardware used to attach the corner casting 128 to a leg 110 includes a cover 136, a mounting bolt 138, a cap 140, springs 142 and bolts 144. To attach the corner casting 128 to trapezoid tube weldments 116, set screws 146 are utilized.

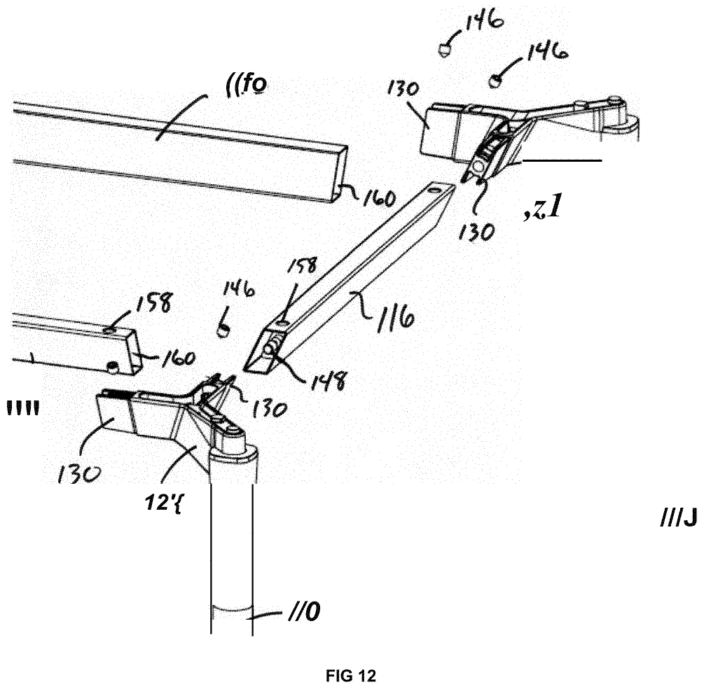

The trapezoidal tube weldments 116 preferably include an integrated machine hardened pin 148 (shown in FIG. 11) with an end 156 that is inserted into a hole 152 in a weld plate 150 and welded in place. The weld plate 150 and machine hardened pin 148 are then inserted into the end 160 of the trapezoid tube weldment 116 and welded in place. The trapezoid tube weldment 116 can then be connected to the corner casting 128 by inserting the insertion portion 130 of the corner casting into the end 160 of a trapezoid tube weldment and securing the corner casting to the machine hardened pin 148 with a set screw 146, as shown in FIG. 12. A hole 158 is provided at each end of the trapezoid tube weldment 116 to allow for insertion of the set screw 146. When connected, the set screw 146 mates with the annular groove 154 of the machine hardened pin 148, drawing the trapezoidal tube weldment 116 into exact alignment with the corner casting 128. The machine hardened pin connection provides many advantages, including a secure and inexpensive connection means that draws the components into the exactly correct position, easy and quick assembly and disassembly and the elimination of multiple screws used in typical table frame connection systems.

The corner castings 128 of the present invention provide modular functionality, allowing different legs 110 to be used with the casting, and different lengths of trapezoid tube weldments 116 to be used, so that table tops of different sizes may be used in conjunction with the trapezoid tube weldments and corner castings. The corner castings 128 are preferably sized with a 3 inch offset from the corner to edge that meets the trapezoid tube weldment 116, allowing the combination to be used with every standard sized table top in 6 inch increments. Applicants also contemplate that a leg and corner casting could be a single piece. The corner casting further allows for insertion in a non-handed leg, allowing all legs used with the system to be interchangeable. In addition to use in conjunction with a leg, the casting connecting the trapezoid tube weldments could be modified to allow it to be connected to a wall.

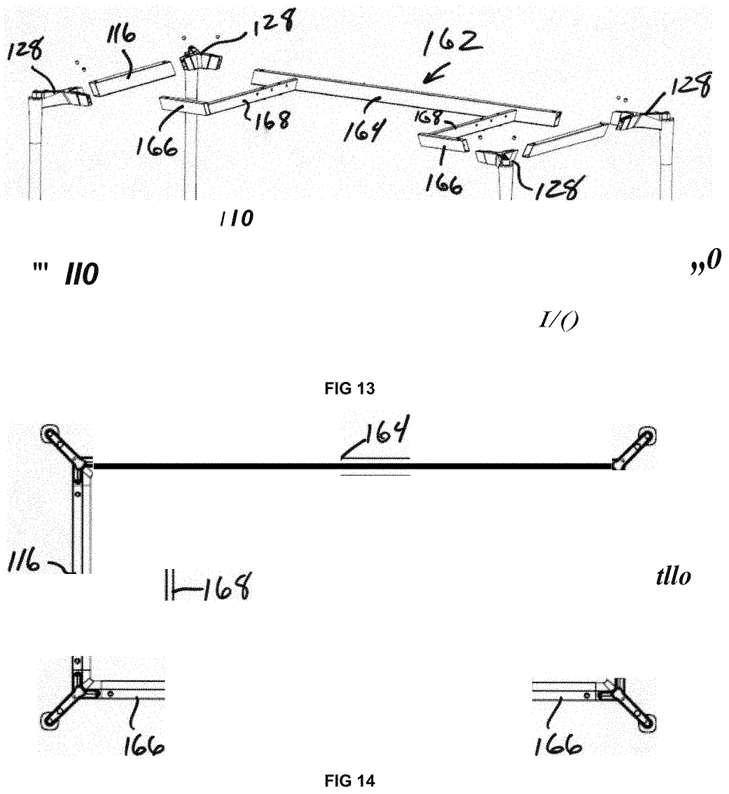

The height adjustable work surface 104 of the present invention is preferably integrated with the novel trapezoidal frame structure 106 with a center weldment structure 162, as shown in FIGS. 13 and 14. The center weldment structure 162 is preferably constructed of welded components, with the rear weldment 164 and front weldments 166 being trapezoidal tubes, and the connecting center tubes 168 being rectangular. The center weldment structure 162 is connected to the corner castings 128 to create a frame as described above.

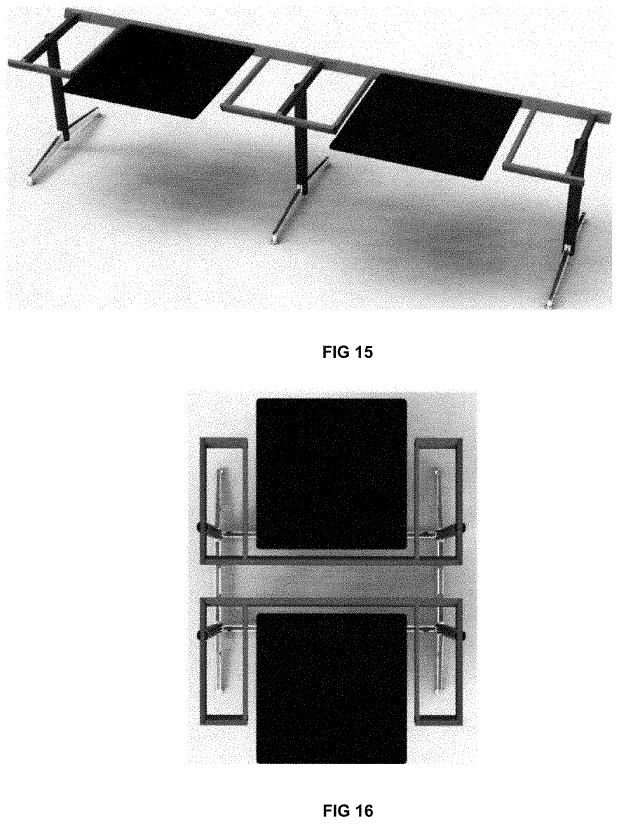

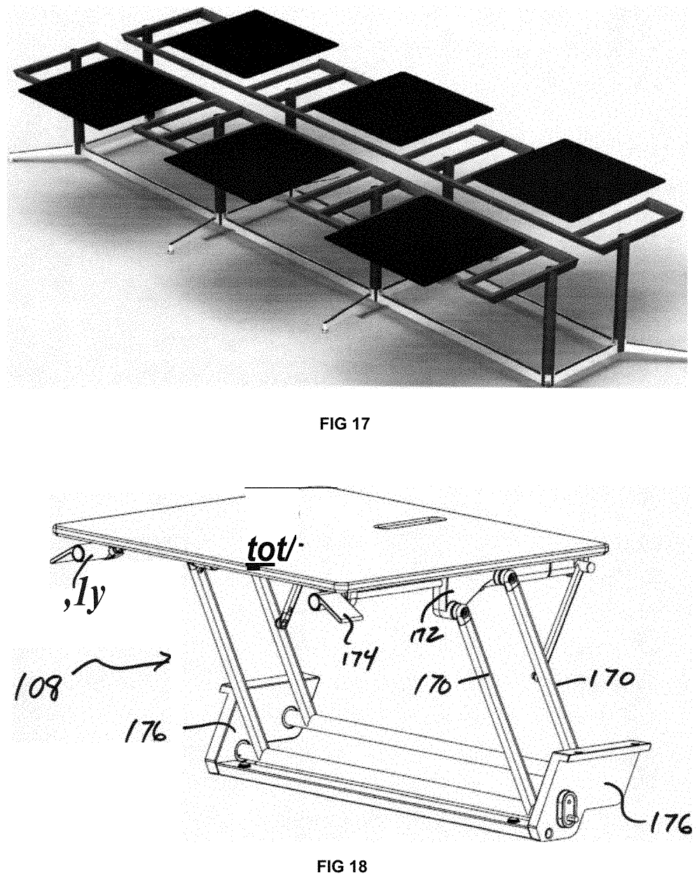

The center weldment structure 162 provides a space for mounting the lift mechanism 108 of the height adjustable portion on the connecting center tubes 168. The center weldment structure 162 may be utilized to create a single user desk with a single height adjustable portion or used in many alternative corner casting and connectivity configurations of multiple table frames, examples of which are shown in FIGS. 15-17.

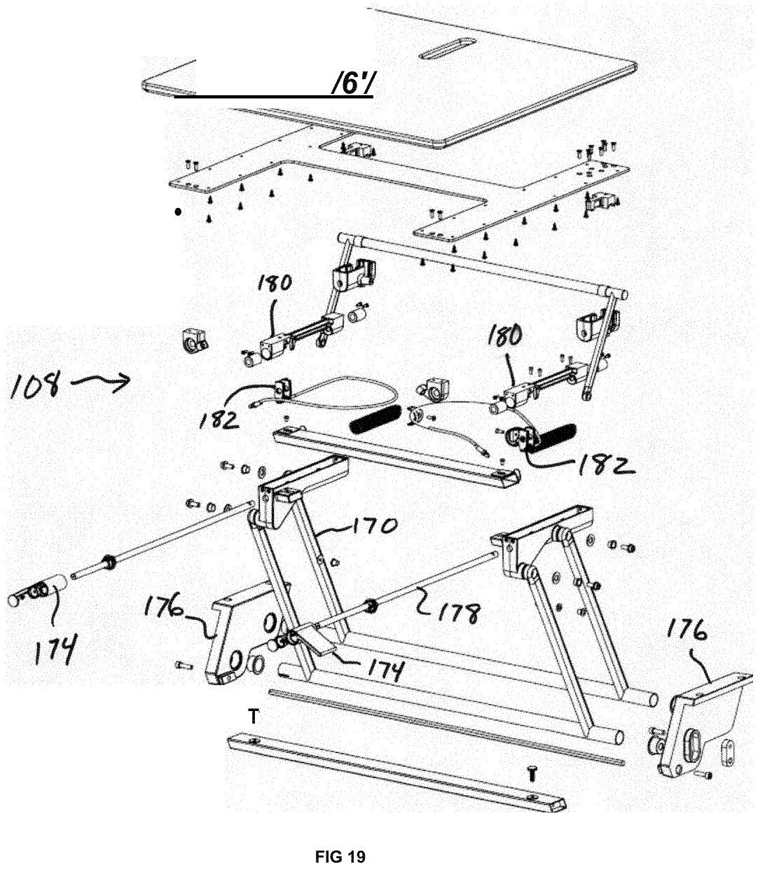

The height adjustable functionality of the present invention is provided by the lift mechanism 108 shown in FIG. 18, that preferably utilizes parallelogram linkages 170, sliding brake bar mechanisms 172 and brake release handles 174. The lift mechanism 108 mounts on the center weldment structure 162 with the mounting plates 176, which hang on and are attached to the connecting center tubes 168 of the center weldment structure. An exploded view of the lift mechanism 108 is shown in FIG. 19.

The functionality of the lift mechanism 108 is facilitated by a parallelogram linkage lift mechanism 170, although other lift mechanisms and configurations would provide similar functionality within the scope of the invention. The parallelogram linkages 170, however, provides certain advantages, including that the height adjustable work surface 104 lifts straight up. Also, the parallelogram linkages 170, unlike a scissor lift, has fewer and less severe pinch points, decreasing the potential for injury to users.

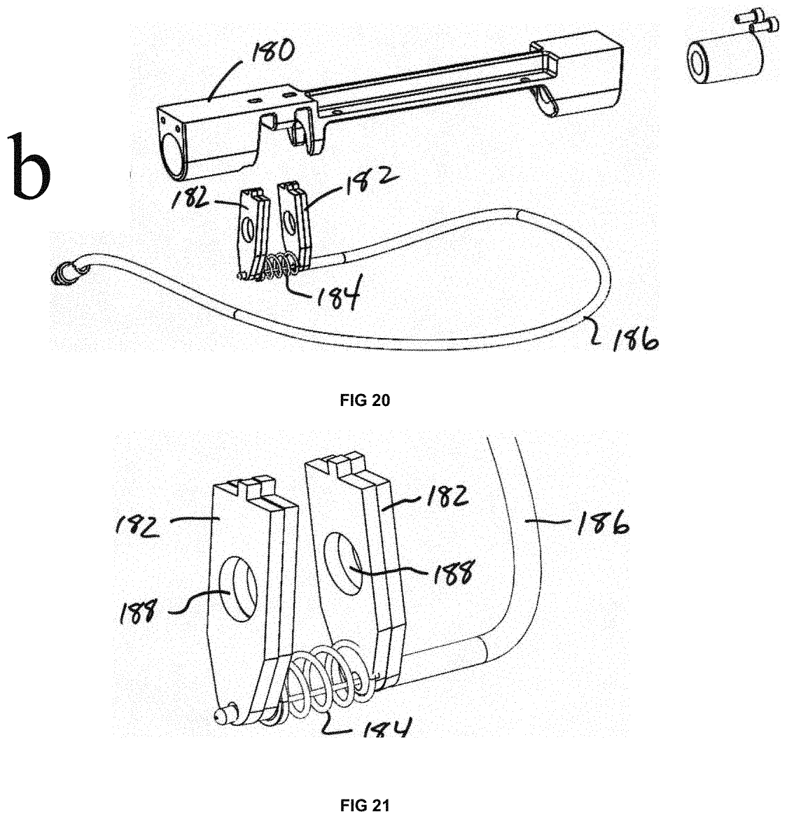

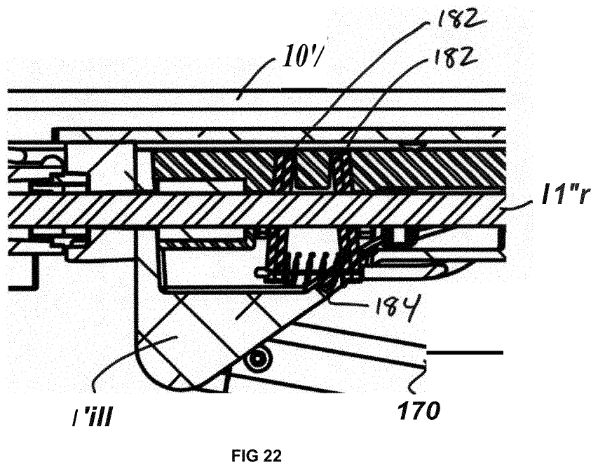

The lift mechanism 108 also includes a hardened brake bar 178 and, as shown in detail in FIGS. 20 and 21, a brake housing 180 that includes brake plates 182 and a spring 184 that may be compressed by the brake release handles 174 via the line 186. In the unlocked position, with the spring compressed, the brake housing 180 may slide on the brake bar 178 with the brake bar passing through the holes 188 as the height adjustable portion 104 of the lift mechanism 108 is raised and lowered. In the locked position, the spring 184 pushes the brake plates 182 into a diagonal position relative to the brake bar 178, holding the brake housing 180 securely to the brake bar 178, as shown in FIG. 22.

To release the brake plates 182, the brake release handles 174 are activated to bring the brake plates 182 to a vertical position relative to the brake bar 178. With the brake plates 182 in a vertical position, the brake housing 180 may slide freely on the brake bar 178.

The brake bar locking mechanism provides many benefits, including that the brake plates 182 may be fixed at any point along the brake bar 178, allowing the height adjustable portion 104 to be positioned and securely held at any height within its range of movement. Thus, the user may position the height adjustable portion at the exact height most comfortable for the individual user.

The mechanism also provides braking in both directions, so that the work surface cannot be raised without releasing the brakes and will not lower without releasing the brakes. Also, both handles must be activated to allow movement of the height adjustable portion 104, keeping both brakes in synch, and preventing a user from having a hand in a position where it could be pinched by the lift mechanism 108. Further, the brake plates 182 are biased outwardly by the spring 184, keeping the brake housing 180 in a locked position unless activated by the user to allow movement.

Although a spring is disclosed for biasing the brake plates 182 outwardly, other means for biasing the plates could be utilized to provide braking, or the plates could be biased inwardly to provide the necessary friction and braking on the brake bar. Those of skill in the art would recognize other alternatives for modifying the preferred embodiment disclosed herein that would nonetheless remain within the scope of the present invention.

The inventors contemplate several alterations and improvements to the disclosed invention. Other alterations, variations, and combinations are possible that fall within the scope of the present invention. Although various embodiments of the present invention have been described, those skilled in the art will recognize more modifications that may be made that would nonetheless fall within the scope of the present invention. Therefore, the present invention should not be limited to the apparatus described. Instead, the scope of the present invention should be consistent with the invention claimed below.

1. A table comprising:
at least two legs;
a frame attached to the at least two legs;
a table top, the table top having a first static portion attached to the frame and a first height adjustable portion that, in a lowered position, is substantially planar with the first static portion;
a lift mechanism attached to the frame and to the first height adjustable portion of the table top, the lift mechanism allowing the first height adjustable portion to be raised and lowered so that the first height adjustable portion has a raised position that is above the first static portion of the table top.

2. The table of claim 1 wherein at least a portion of the frame has a trapezoidal cross section.

3. The table of claim 1 wherein the frame includes at least one hollow metal tube.

4. The table of claim 3 wherein the at least one hollow metal tube has a trapezoidal cross section.

5. The table of claim 1 wherein the frame comprises hollow metal tubes attached to metal castings, the metal castings attached to the at least three legs of the table.

6. The table of claim 5 wherein the hollow metal tubes have a trapezoidal cross section.

7. The table of claim 1 wherein the lift mechanism includes a brake mechanism that slides on a bar attached to the second height adjustable portion of the table.

8. The table of claim 7 wherein the brake mechanism includes at least one brake plate that, in a first position, allows the brake mechanism to slide on the bar and, in a second position, prevents the brake mechanism from sliding on the bar.

9. The table of claim 8 wherein the at least one brake plate prevents the brake mechanism from sliding on the bar by locking onto the bar and preventing the brake plate from moving relative to the bar.

10. The table of claim 9 wherein the at least one brake plate is released from locking onto the bar by at least one brake handle.

11. The table of claim 1 wherein the lift mechanism includes a brake mechanism that locks the first height adjustable portion of the table top into the raised position.

12. The table of claim 11 wherein the lift mechanism includes a brake release handle that releases the first height adjustable portion from the raised position.

13. The table of claim 1 wherein the lift mechanism includes a brake mechanism comprised of two brake plates that
1) in a parallel unlocked position, allow the brake mechanism to slide on a brake bar connected to the first height adjustable portion, with the brake bar passing through the brake plates, and
2) in a nonparallel locked position, do not allow the brake mechanism to slide on the brake bar.

14. The table of claim 13 wherein the brake mechanism also comprises a spring that biases the two brake plates into the nonparallel position.

15. The table of claim 14 wherein the lift mechanism also includes a brake release handle connected to a line that, upon activation of the brake release handle, compresses the spring to unlock the braking mechanism.

16. A table comprising:
at least two legs;
a frame attached to the at least two legs;
a table top, the table top having a first static portion attached to the frame, a first height adjustable portion and a second height adjustable portion;
a first lift mechanism attached to the frame and to the first height adjustable portion of the table top, the first lift mechanism capable of raising and lowering the first height adjustable portion so that the first height adjustable portion may be raised to a position above the first static portion of the table top; and
a second lift mechanism attached to the frame and to the second height adjustable portion of the table top, the second lift mechanism capable of raising and lowering the second height adjustable portion so that the second height adjustable portion may be raised to a position above the first static portion of the table top.

17. The table of claim 16 further comprising a third height adjustable of the table top; and
a third lift mechanism attached to the frame and to the third height adjustable portion of the table top, the third lift mechanism capable of raising and lowering the third height adjustable portion so that the third height adjustable portion may be raised to a position above the first static portion of the table top.

18. The table of claim 16 wherein at least a portion of the frame has a trapezoidal cross section.

19. The table of claim 16 wherein the frame includes at least one hollow metal tube.

20. The table of claim 19 wherein the at least one hollow metal tube has a trapezoidal cross section.

21. The table of claim 16 wherein the first lift mechanism includes a brake mechanism capable of locking the first height adjustable portion of the table top into a raised position.

22. The table of claim 21 wherein the lift mechanism includes a brake release handle that releases the first height adjustable portion from the raised position.

23. The table of claim 22 wherein the lift mechanism includes a brake mechanism comprised of two brake plates that
1) in a parallel unlocked position, allow the brake mechanism to slide on a brake bar connected to the second height adjustable portion, with the brake bar passing through the brake plates, and
2) in a nonparallel locked position, do not allow the brake mechanism to slide on the brake bar.

24. A table comprising:
at least two legs;
a frame attached to the at least two legs;
a table top;
a lift mechanism attached to the frame and to the table top, the lift mechanism allowing the table top to be raised and lowered;
a brake mechanism capable of locking the table top into a raised position, the brake mechanism comprised of two brake plates that
1) in a parallel unlocked position, allow the brake mechanism to slide on a brake bar connected to the second height adjustable portion, with the brake bar passing through the brake plates, and
2) in a nonparallel locked position, do not allow the brake mechanism to slide on the brake bar.

25. The table of claim 24 wherein the brake mechanism also comprises a spring that biases the two brake plates into the nonparallel position.

26. The table of claim 25 wherein the lift mechanism also includes a brake release handle connected to a line that, upon activation of the brake release handle, compresses the spring to unlock the braking mechanism.

27. The table of claim 24 wherein at least a portion of the frame has a trapezoidal cross section.

28. The table of claim 24 wherein the frame includes at least one hollow metal tube.

29. The table of claim 28 wherein the at least one hollow metal tube has a trapezoidal cross section.
